(19) United States
(12) Patent Application Publication
(10) Pub. No.: US 2017/0192796 A1
(43) Pub. Date: Jul. 6, 2017

(54) METHODS AND SYSTEMS FOR CONFIGURING A DEVICE USING A FIRMWARE CONFIGURATION BLOCK

(71) Applicant: Robert Bosch GmbH, Stuttgart (DE)

(72) Inventors: Satheesh Kumar Kunjuraman, Rochester, NY (US); Alex Khazanov, Rochester, NY (US); Othmane Bennis, Rochester, NY (US)

(21) Appl. No.: 15/214,066

(22) Filed: Jul. 19, 2016

Related U.S. Application Data
(60) Provisional application No. 62/273,102, filed on Dec. 30, 2015.

(51) Int. Cl. G06F 9/44; G06F 9/445

(52) U.S. Cl. CPC G06F 9/4411; G06F 8/65

(57) ABSTRACT

Methods and systems for configuring a device. One method includes receiving, with an electronic processor, a firmware block and a firmware configuration block from a hub. The firmware configuration block includes configuration parameters for the firmware block. The method also includes executing, with the electronic processor, the firmware block based on the configuration parameters included in the firmware configuration block to operate the device. The method also includes receiving, with the electronic processor, an updated firmware configuration block. The updated firmware configuration block includes updated configuration parameters for the firmware block. The method also includes executing, with the electronic processor, the firmware block based on the updated configuration parameters included in the updated configuration block to operate the device.

### RELATED APPLICATIONS

This application claims priority to U.S. Provisional Application No. 62/273,102 filed on Dec. 30, 2015, the entire content of which is herein incorporated by reference.

### FIELD

Embodiments of the invention relate to methods and systems for configuring a device.

### BACKGROUND

End-user systems in different use cases (e.g., a security system, a building automation system, or similar system) may include a plurality of devices installed throughout a premises (e.g., a building). The plurality of devices may make up an internal network system. The plurality of devices may include sensors (e.g., a motion sensor, a humidity sensor, a light sensor, a pressure sensor, and the like) for performing various sensing functions. The capabilities and functions (e.g., the sensing functions) are configured and managed according to, for example, the applicable use case and/or services to be provided by the internal network system.

### SUMMARY

The configuration and management of such an internal network system and the networked devices within that internal network system generally requires hardware configuration settings to be performed manually or by defining proprietary protocol mechanisms. Such configuration and management makes installation, maintenance, reconfiguration, and upgrade of such internal network systems and the networked devices within those internal network systems complex and costly. For example, in many instances, sensor firmware and/or radio firmware changes may require regulatory re-certification. Remote over-the-air and similar network firmware upgrade mechanisms may be used to upgrade software in many devices without manually installing the upgrade. Such devices may include devices that are compliant with certain wireless protocols (e.g., ZigBee, Z-wave, etc.). By providing a user-defined firmware file format, an over-the-air upgrade mechanism may also be used to manage device configurations (e.g., regional parameters) and options (e.g., enable/disable sensors) remotely, in many cases with no changes to the rest of the system. Using standard upgrade mechanisms to reconfigure and upgrade such networked devices reduces these issues and helps to avoid significant changes to the system that may require regulatory re-certification. However, the standard protocol definition may not define all the different device options on a single networked device. This requires proprietary implementation of configuration commands or manual configuration of the networked device or updating a new firmware to the networked device.

Accordingly, embodiments provide methods and systems for remotely configuring a device. In some embodiments, bulk configuration (e.g., updating the configuration of a group or all the devices of a particular type in an ecosystem) is provided. In some embodiments, the capability of a device may be quickly changed by updating only a single block (e.g., 64 bytes) of the firmware, such as a firmware configuration block. Therefore, a complete upgrade of the device firmware is not required. Furthermore, there is no need for regulatory re-certification because only the configuration and/or options are changing.

For example, one embodiment provides a method for configuring a device. The method includes receiving, with an electronic processor, a firmware block and a firmware configuration block from a hub. The firmware configuration block includes configuration parameters for the firmware block. The method also includes executing, with the electronic processor, the firmware block based on the configuration parameters included in the firmware configuration block to operate the device. The method also includes receiving, with the electronic processor, an updated firmware configuration block. The updated firmware configuration block includes updated configuration parameters for the firmware block. The method also includes executing, with the electronic processor, the firmware block based on the updated configuration parameters included in the updated configuration block to operate the device.

Another embodiment provides a system for configuring a device. The system includes a server having a first electronic processor. The first electronic processor is configured to transmit a firmware block and a firmware configuration block. The firmware configuration block includes configuration parameters for the firmware block. The first electronic processor is also configured to transmit an updated firmware configuration block. The updated firmware configuration block includes updated configuration parameters for the firmware block. The system also includes a device. The device includes a sensor and a second electronic processor. The second electronic processor is configured to receive, via an input/output interface, the firmware block and the firmware configuration block. The second electronic processor is also configured to execute the firmware block based on the configuration parameters included in the firmware configuration block to operate the device. The second electronic processor is also configured to receive the updated firmware configuration block. The second electronic processor is also configured to execute the firmware block based on the updated configuration parameters included in the updated configuration block to operate the device.

Another embodiment provides a device. A device includes an input/output interface, a sensor, and an electronic processor. The electronic processor is configured to receive, via the input/output interface, a firmware block and a firmware configuration block. The firmware configuration block includes configuration parameters for the firmware block. The electronic processor is also configured to execute the firmware block based on the configuration parameters included in the firmware configuration block to operate the device. The electronic processor is also configured to receive, via the input/output interface, an updated firmware configuration block. The updated firmware configuration block includes updated configuration parameters for the firmware block. The electronic processor is also configured to execute the firmware block based on the updated configuration parameters included in the updated configuration block to operate the device.

Other aspects of the invention will become apparent by consideration of the detailed description and accompanying drawings.

### BRIEF DESCRIPTION OF THE DRAWINGS

FIG. 1 schematically illustrates a premises with an internal network system that includes a plurality of networked devices according to some embodiments.

FIG. 2 schematically illustrates one of a plurality of networked devices included in the premises of FIG. 1 according to some embodiments.

FIG. 3 schematically illustrates a system for configuring the plurality of networked devices included in the premises of FIG. 1 according to some embodiments.

FIG. 4 is a flowchart illustrating a method for configuring the networked device of FIG. 2 according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including wired connections, wireless connections, etc. It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification may include one or more electronic processors, one or more memory modules including non-transitory computer-readable medium, one or more input/output interfaces, and various connections (e.g., a system bus) connecting the components.

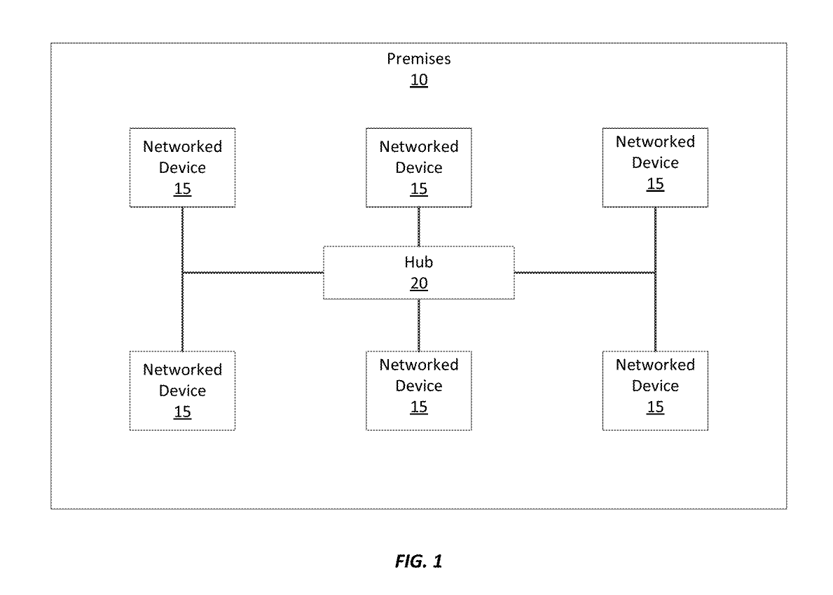

FIG. 1 schematically illustrates a premises 10 (e.g., a building). In the example illustrated, the premises 10 includes an internal network system having a plurality of networked devices 15 (e.g., a security detector with optional sensors). The internal network system provides, for example, a security system, a building automation system, a similar system, or a combination thereof for the premises 10. The plurality of networked devices 15 are positioned (e.g., installed) at various locations throughout the premises 10. The plurality of networked devices 15 are communicatively connected (via a wired or wireless connection) through a hub 20. The hub 20 can be, for example, a controller or a gateway. The premises 10 illustrated in FIG. 1 is provided as one example of a premises, and the embodiments described herein may be used with any type of premises and are not limited to the example premises 10 illustrated in FIG. 1.

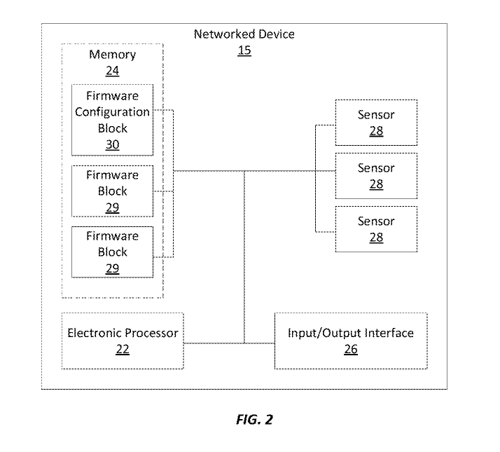

FIG. 2 schematically illustrates one of the plurality of networked devices 15 (referred to as the “networked device 15” herein). The networked device 15 includes combinations of hardware and software that are operable to, among other things, perform the methods described herein. In the example illustrated, the networked device 15 includes an electronic processor 22 (e.g., a microprocessor, application specific integrated circuit, or other suitable electronic device), a memory 24 (e.g., one or more non-transitory computer-readable storage mediums), and an input/output interface 26. The networked device 15 also includes one or more sensors 28. The electronic processor 22, the memory 24, the input/output interface 26, and the sensors 28 communicate over one or more control or data connections or buses. The networked device 15 illustrated in FIG. 2 represents one example, and, in some embodiments, the networked device 15 may include additional, fewer, or different components in different configurations. Also, in some embodiments, the networked device 15 performs functionality in addition to the functionality described herein.

The electronic processor 22 is configured to retrieve, from the memory 24, instructions and execute the instructions to perform a set of functions, including the methods described herein. The memory 24 may include combinations of different types of memory, such as read-only memory (“ROM”), random access memory (“RAM”), or another non-transitory computer readable medium. As noted above, the memory 24 stores instructions executable by the electronic processor 22. The memory 24 may also store data. Accordingly, the memory 24 may store firmware, one or more applications, program data, filters, rules, one or more program modules, and other executable instructions or data. For example, in the example illustrated in FIG. 2, the memory 24 stores one or more firmware blocks 29. In some embodiments each firmware block includes firmware for a particular component or functionality of the networked device 15. For example, the memory 24 may store a radio firmware block (e.g., including firmware for the input/output interface 26) and a sensor firmware block (e.g., including firmware for one or more of the sensors 27. As illustrated in FIG. 2, the memory 24 also stores a firmware configuration block 30. As described in more detail below, the firmware configuration block 30 stores configuration parameters for components or functionality of the networked device 15.

The input/output interface 26 allows the networked device 15 to communicate with devices external to the networked device 15 (e.g., receive input and provide output to and from systems external to the networked device 15). For example, the networked device 15 may communicate with the hub 20 and/or other networked devices within the internal network system through the input/output interface 26. In particular, the input/output interface 26 may include a port for receiving a wired connection to the hub 20 (e.g., an Ethernet cable, a universal serial bus (“USB”) cable and the like), a radio transceiver for establishing a wireless connection to the hub 20 (e.g., over a communication network, such as the Internet, a local area network (“LAN”), a wide area network, and the like), or a combination thereof.

The sensors 28 may include, for example, a temperature sensor, a humidity sensor, a motion sensor, a pressure sensor, an audio sensor, and the like. The sensors 28 may be configured to collect data relating to the premises 10 (e.g., temperature data, humidity data, pressure data, sound data, motion data, and the like). For example, a sensor 28 may be configured to collect temperature data relating to a specific room in the premises 10 in which the networked device 15 is installed. The data collected by the sensors 28 may be transmitted to the hub 20 through the input/output interface 26, and the hub 20 may process the data from the sensors 28 to determine whether any warnings, alarms, or other actions should be taken. In some embodiments, the networked device 15 (i.e., the electronic processor 22) may process the data from the sensors 28 before the data is transmitted to the hub 20 or may process the data from the sensors 28 and determine automatic actions to take without communicating with the hub 20.

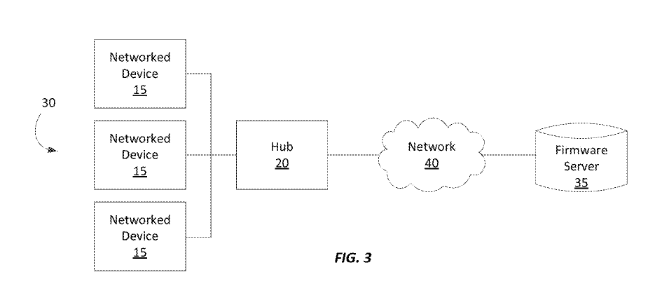

FIG. 3 illustrates a system 30 for configuring the networked device 15. The system 30 includes the networked device 15, the hub 20, and a firmware server 35. The system 30 may include fewer, additional, or different components than illustrated in FIG. 3. For example, in some embodiments, the system 30 includes multiple firmware servers 35, multiple hubs 20, multiple networked devices 15, or a combination thereof.

The firmware server 35 receives and stores new firmware files (e.g., firmware blocks). As mentioned above, the networked device 15 is communicatively connected (via a wired or wireless connection) to the hub 20, and the hub 20 is communicatively connected to a firmware server 35. In the example illustrated in FIG. 3, the firmware server 35 communicates with (e.g., transmits data to) the hub 20 over a network 40. The network 40 may include the Internet, a cellular network, a public network, a private network, or other wired or wireless network. In some embodiments, the firmware server 35 communicates with the hub 20 indirectly through one or more intermediary computing devices. In some embodiments, the functionality performed by the firmware server 35 is performed by the hub 20 or vice versa.

In some embodiments, the firmware server 35 may push a firmware block to the networked device 15 by transmitting the new firmware blocks to the hub 20, which forwards the firmware blocks to the networked device 15. Alternatively or in addition, a networked device 15 may request a firmware block from the firmware server 35 through the hub 20. Protocols for distributing firmware to devices over a wireless communication channel (i.e., over-the-air programming) are well-known and, therefore, are not discussed in detail herein.

The plurality of networked devices 15 can be configured to perform a variety of functionalities, capabilities, and options. For example, the plurality of networked devices 15 can be configured to sense the temperature, humidity, pressure, sounder, and the like of the premises 10. However, a service provider associated with the internal network system may designate what features and capabilities are provided for a particular end user or a particular device based on, for example, a service contract. For example, one end user may have purchased a basic security service that only monitors for motion and not temperature, pressure, or sound and another end user may have purchased a premium security service that includes monitoring for motion, temperature, and sound. An end user may change service levels from time to time. Also, different services may be available to different end users depending on the end user's location (e.g., regional settings may differ).

Accordingly, each time an internal network system is set up or re-configured, firmware blocks may need to be provided to each networked device to provide each networked device with the proper firmware for performing the desired functionality. This type of set-up or reconfiguration may be complex and costly. For example, in many instances, sensor firmware or radio firmware changes may require regulatory re-certification. Furthermore, even if these configurations can be performed remotely (e.g., using over-the-air programming), these configurations may require proprietary implementations, which again is complex and costly.

Thus, in some embodiments, the networked device 15 initially stores (in the memory 24) one or more firmware blocks 29 for performing a set of functionality as part of a standard installation. The networked device 15 may also store one or more firmware configuration blocks 30. The firmware configuration blocks 30 include configuration parameters for the firmware blocks 29, such as what sensors 28 should be enabled, sensitivity values for the sensors 28, what thresholds should be used for generating commands, and the like. Accordingly, when the networked device 15 needs to be reconfigured, in some embodiments, only the firmware configuration block 30 is updated (e.g., from the firmware server 35) and no new firmware blocks 29 need to be transmitted and implemented (e.g., re-certified).

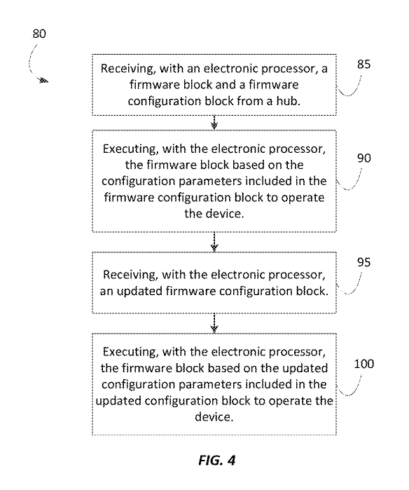

For example, FIG. 4 illustrates a method 80 for configuring the networked device 15. The method 80 is described as being performed by the networked device 15 (i.e., the electronic processor 22 executing instructions stored in the memory 24). In some embodiments, however, all or a portion of the method 80 may be performed by a device separate from the networked device 15, such as the hub 20 or the firmware server 35. Also, the method 80 may be applied to any type of device and is not limited to the networked device 15 illustrated in FIG. 2. For example, the method 80 may be used with devices that include fewer, additional, or different input, components, sensors, and the like than the networked device 15.

As illustrated in FIG. 4, the method 80 includes receiving, with the electronic processor 22, a firmware block 29 and a firmware configuration block 30 from the hub 20 (at block 85). The networked device 15 receives the firmware block 29 and the firmware configuration block 30 via the input/output interface 26 from the firmware server 35 (e.g., through the hub 20). The firmware block 29 and the firmware configuration block 30 may be transmitted to the network device 15 using a standard firmware upgrade protocol or mechanism. Thus, proprietary configuration command implementation on either end of the subsystem can be avoided.

The firmware configuration block 30 may define the functionality and options for the received firmware block 29, and, consequently, the functionality and options of the networked device 15. For example, in some embodiments, the firmware configuration block 30 includes configuration parameters for the firmware block 29. Also, in some embodiments, the firmware configuration block 30 includes configuration parameters for additional firmware blocks 29 (e.g., a second firmware block, a third firmware block, and the like). As described above, the configuration parameters may include, among other things, a state (e.g., enabled or disabled) of at least one of the sensors 28 included in the networked device 15 and/or a setting (e.g., a sensitivity or associated threshold) for at least one of the sensors 28 included in the networked device 15. As mentioned above, in some embodiments, the configuration parameters included in the firmware configuration block 30 may be based on the designated features and capabilities for a particular end user or a particular device according to a service agreement between the end user (e.g., a customer) and a service provider. For example, the firmware configuration block 30 may include configuration parameters that are specific to a customer (e.g., based on a service agreement between the customer and a service provider). In some embodiments, in addition to or alternatively, the firmware configuration block 30 may include service-level related or regional settings or changes.

In some embodiments, the firmware configuration block 30, additionally or alternatively, includes regional settings (e.g., transmit power levels), installation baselines (e.g., “updating” all devices installed in 2015 to mark those devices), and the like. Additionally, in some embodiments, the firmware configuration block 30 may include an identification of a specific firmware block 29 to execute. For example, in some embodiments, the networked device 15 may be initially installed with a plurality of firmware blocks 29, wherein each of the plurality of firmware blocks 29 may be executed to perform different functionality. The firmware configuration block 30 may then designate one of the firmware blocks 29 to execute from among the available firmware blocks 29. Hence, functionality provided by the networked device 15 may be updated through updates to the firmware configuration block 30 without requiring updates to the firmware blocks 29. Accordingly, in some situation, re-certificate may not be required.

The method 80 also includes executing, with the electronic processor 22, the firmware block 29 based on the configuration parameters included in the firmware configuration block 30 to operate the networked device 15 (at block 90). For example, the networked device 15 (i.e., the electronic processor 22) may execute the firmware block 29 according to the configuration parameters (e.g., a specific sensitivity value for one of the sensors 28) included in the firmware configuration block 30.

The method 80 also includes receiving, with the electronic processor 22, an updated firmware configuration block 30 (at block 95). The networked device 15 (i.e., the electronic processor 22) receives the updated firmware configuration block 30 via the input/output interface 26 from the firmware server 35 (through the hub 20). The updated firmware configuration block 30 may define the updated functionality and options of the networked device 15. For example, in some embodiments, the updated firmware configuration block 30 includes updated configuration parameters for the firmware block 29. In some embodiments, the updated firmware configuration block 30 includes updated configuration parameters for additional firmware blocks 29 (e.g., a second firmware block, a third firmware block, and the like). For example, the updated configuration parameters may include, among other things, an updated state (e.g., enabled or disabled) of at least one of the sensors 28 included in the networked device 15 and/or an updated setting (e.g., a sensitivity) for at least one of the sensors 28 included in the networked device 15.

In some embodiments, the updated configuration parameters included in the updated firmware configuration block 30 are based on an updated service agreement between an end user and a service provider. For example, an end user may have initially purchased a basic security service that only monitors for motion and not temperature, pressure, or sound. When the end user decides to change the service level from a basic security service to a premium security service that includes monitoring for motion, temperature, pressure, and sound, the updated firmware configuration block 30 (as received at block 95 in method 80) may include updated configuration parameters for monitoring the temperature, pressure, and sound in addition to motion. The updated configuration parameters may include, for example, the updated state of enabled for the sensors 28 (e.g., a temperature sensor, a pressure sensor, and a sound sensor) used for monitoring temperature, pressure, and sound.

After receiving the updated firmware configuration block 30 (at block 95), the networked device 15 (i.e., the electronic processor 22) executes the firmware block 29 based on the updated configuration parameters included in the updated configuration block 30 to operate networked device 15 (at block 100). In some embodiments, the networked device 15 (i.e., the electronic processor 22) executes the firmware block 29 based on the updated configuration block 30 without receiving an updated version of the firmware block. When the firmware block 29 is executed based on the updated configuration parameters included in the updated configuration block 30, the operation (e.g., the functionality and/or options) of the networked device 15 is updated. For example, following the example provided above, the updated operation of the networked device 15 may include monitoring motion, temperature, pressure, and sound. Therefore, the electronic processor 22 executes the firmware block 29 (in accordance with the updated firmware configuration block 30) so that the operation of the networked device 15 includes monitoring motion, temperature, pressure, and sound. In some embodiments, the updated operation of the networked device 15 includes updating a setting (e.g., a specific sensitivity value) of one or more of the sensors 28 that have been previously enabled.

Thus, the invention provides, among other things, methods, systems, and apparatuses for configuring a device using a firmware configuration block. Using a firmware configuration block allows devices, such as devices included in a security system for a premises, to be configured and reconfigured without requiring the update of a new firmware version or implementation of proprietary and complex configuration commands.

Various features and advantages of the invention are set forth in the following claims.

What is claimed is:

1. A method for configuring a device, the method comprising:
receiving, with an electronic processor, a firmware block and a firmware configuration block from a hub, the firmware configuration block including configuration parameters for the firmware block;
executing, with the electronic processor, the firmware block based on the configuration parameters included in the firmware configuration block to operate the device;
receiving, with the electronic processor, an updated firmware configuration block, the updated firmware configuration block including updated configuration parameters for the firmware block; and
executing, with the electronic processor, the firmware block based on the updated configuration parameters included in the updated configuration block to operate the device.

2. The method of claim 1, wherein executing the firmware block based on the updated configuration parameters includes executing the firmware block based on the updated configuration parameters without receiving an updated version of the firmware block.

3. The method of claim 1, wherein receiving the updated firmware configuration block includes receiving an updated state of a sensor included in the device.

4. The method of claim 3, wherein receiving the updated state of the sensor includes receiving an updated state of at least one selected from a group consisting of enabled or disabled.

5. The method of claim 1, wherein receiving the updated firmware configuration block includes receiving an updated setting for a sensor included in the device.

6. The method of claim 1, wherein receiving the updated firmware configuration block includes receiving at least one selected from a group consisting of a regional setting and an installation baseline setting.

7. The method of claim 1, wherein receiving the updated firmware configuration block includes receiving the updated firmware configuration block over a wireless communication network.

8. The method of claim 1, wherein receiving the updated firmware configuration block includes receiving updated configuration parameters for the first firmware block and a second firmware block.

9. A system for configuring a device, the system comprising:
a server having a first electronic processor, the first electronic processor configured to
transmit a firmware block and a firmware configuration block, the firmware configuration block including configuration parameters for the firmware block, and
transmit an updated firmware configuration block, the updated firmware configuration block including updated configuration parameters for the firmware block; and
a device including a sensor and a second electronic processor, the second electronic processor configured to
receive, via an input/output interface, the firmware block and the firmware configuration block,
execute the firmware block based on the configuration parameters included in the firmware configuration block to operate the device,
receive the updated firmware configuration block, and
execute the firmware block based on the updated configuration parameters included in the updated configuration block to operate the device.

10. The system of claim 9, wherein the firmware configuration block includes a state of the sensor included in the device, and wherein the updated firmware configuration block includes an updated state of the sensor included in the device.

11. The system of claim 10, wherein the state of the sensor and the updated state of the sensor is at least one state selected form a group consisting of enabled or disabled.

12. The system of claim 9, wherein the firmware configuration block includes a setting for the sensor included in the device, and wherein the updated firmware configuration block includes an updated setting for the sensor included in the device.

13. The system of claim 9, wherein the updated firmware configuration block includes at least one selected from a group consisting of a regional setting and an installation baseline setting.

14. The system of claim 9, further comprising:
a second device, the second device having a second sensor and a third electronic processor, the third electronic processor configured to
receive, via a second input/output interface, the firmware block and the firmware configuration block,
execute the firmware block based on the configuration parameters included in the firmware configuration block to operate the device,
receive the updated firmware configuration block, and
execute the firmware block based on the updated configuration parameters included in the updated configuration block to operate the device.

15. A device, the device comprising:
an input/output interface;
a sensor; and
an electronic processor, the electronic processor configured to
receive, via the input/output interface, a firmware block and a firmware configuration block, the firmware configuration block including configuration parameters for the firmware block,
execute the firmware block based on the configuration parameters included in the firmware configuration block to operate the device,
receive, via the input/output interface, an updated firmware configuration block, the updated firmware configuration block including updated configuration parameters for the firmware block, and
execute the firmware block based on the updated configuration parameters included in the updated configuration block to operate the device.

16. The device of claim 15, wherein the firmware configuration block includes a state of the sensor included in the device, and wherein the updated firmware configuration block includes an updated state of the sensor included in the device.

17. The device of claim 16, wherein the state of the sensor and the updated state of the sensor is at least one state selected form a group consisting of enabled or disabled.

18. The device of claim 15, wherein the firmware configuration block includes a setting for the sensor included in the device, and wherein the updated firmware configuration block includes an updated setting for the sensor included in the device.

19. The device of claim 15, wherein the firmware configuration block and the updated firmware configuration block includes at least one selected from a group consisting of a regional setting and an installation baseline setting.

20. The device of claim 15, wherein the sensor includes at least one selected from the group consisting of a motion sensor, a pressure sensor, a humidity sensor, a temperature sensor, and an audio sensor.
